(19) United States
(12) Patent Application Publication
(10) Pub. No.: US 2015/0015546 A1
(43) Pub. Date: Jan. 15, 2015

(54) STYLUS AND METHOD FOR MANUFACTURING A STYLUS

(71) Applicant: HTC Corporation, Taoyuan County (TW)

(72) Inventors: Shih-Po Chien, Taoyuan County (TW); Pi-Lin Lo, Taoyuan County (TW); Yu-Jing Liao, Taoyuan County (TW); I-Cheng Chuang, Taoyuan County (TW)

(21) Appl. No.: 13/938,221

(22) Filed: Jul. 9, 2013

(51) Int. Cl. G06F 3/0354

(52) U.S. Cl. CPC G06F 3/03545
USPC 345/179; 264/104

(57) ABSTRACT

A stylus includes a rod and a conductive material. The rod has a first end that is tapered to form a tip, and the conductive material covers all surfaces of the rod. A method for manufacturing a stylus includes following steps. A rod is provided. The rod is placed between a first mold core and a second mold core. The first and second mold cores are combined, so that the rod is located in a mold cavity constructed by the first and second mold cores. A conductive material is formed in the mold cavity. The conductive material is cured on a surface of the rod to form a stylus. The first and second mold cores are separated from each other. The resultant stylus located between the first and second mold cores is taken out.

### TECHNOLOGY FIELD

The application relates to a stylus and a method for manufacturing a stylus.

### RELATED ART

A stylus is a tool shaped as a pen for inputting commands to a computer screen, a mobile apparatus, a graphics tablet, or any other device with a touch screen. By means of the stylus, a user is capable of clicking on the touch screen to select files or to hand-draw images or graphics.

### SUMMARY OF THE INVENTION

The application provides a stylus for clicking on a touch screen.

The application provides a method for manufacturing a stylus in order to form the stylus.

A stylus of the application that includes a rod and a conductive material is provided. The rod has a first end that is tapered to form a tip, and the conductive material covers all surfaces of the rod.

A stylus of the application that includes a rod and a conductive material is provided. The rod includes a first part and a second part. The first part has a first end and a second end. The first end is tapered to form a tip, and the second part has a third end that is connected to the second end. The conductive material encapsulates the first and second ends.

A method for manufacturing a stylus of the application includes following steps. A rod is provided. The rod is placed between a first mold core and a second mold core. The first and second mold cores are combined, so that the rod is located in a mold cavity constructed by the first and second mold cores. A conductive material is formed in the mold cavity. The conductive material is cured on a surface of the rod to form a stylus. The first and second mold cores are separated from each other. The resultant stylus between the first and second mold cores is taken out.

In view of the above, the stylus of the application described herein is composed of the rod and the conductive material that encapsulates the rod. Besides, according to the method for manufacturing the stylus of the application described above, the rod is positioned in the mold cavity, such that the conductive material may encapsulate the rod to form the stylus.

In order to make the aforementioned and other features and advantages of the application more comprehensible, embodiments accompanying figures are described in detail below.

### BRIEF DESCRIPTION OF THE DRAWINGS

FIG. 1 is a side view illustrating a stylus according to an embodiment of the application.

FIG. 2 is a cross-sectional view taken along line A-A in FIG. 1.

FIG. 3 is a three-dimensional view illustrating a rod of the stylus in FIG. 1.

FIG. 4 is an exploded view illustrating a rod and a magnetic element in the stylus depicted in FIG. 1.

FIG. 5A and FIG. 5B illustrate a method for manufacturing a stylus according to an embodiment of the application.

FIG. 6 illustrates a stylus according to another embodiment of the application.

FIG. 7 is a side view illustrating a rod of the stylus in FIG. 6.

FIG. 8A and FIG. 8B illustrate a method for manufacturing a stylus according to another embodiment of the application.

### EMBODIMENTS

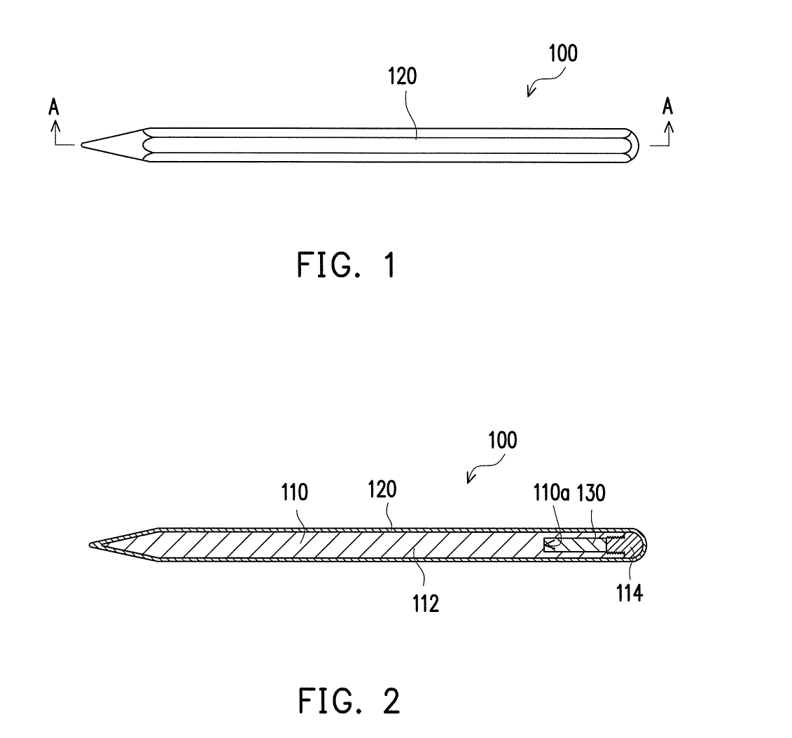

FIG. 1 is a side view illustrating a stylus according to an embodiment of the application. FIG. 2 is a cross-sectional view taken along line A-A in FIG. 1. With reference to FIG. 1 and FIG. 2, the stylus 100 described in the present embodiment includes a rod 110 and a conductive material 120 that encapsulates the rod 110. According to the present embodiment, the rod 110 may be made of metal to ensure favorable structural strength, and the conductive material 120 may be conductive rubber in consideration of conductivity and flexibility, which should however not be construed as limitations in the application.

As shown in FIG. 2, to trigger certain functions of an electronic apparatus (not shown) or for other possible purposes, the stylus 100 described herein may further include a magnetic element 130 that is located in the rod 110. Hence, when the stylus 100 is moved toward or away from the electronic apparatus, the magnetic element 130 is moved toward or away from the electronic apparatus as well, and the resultant changes to the magnetic field around the electronic apparatus may trigger certain functions of the electronic apparatus.

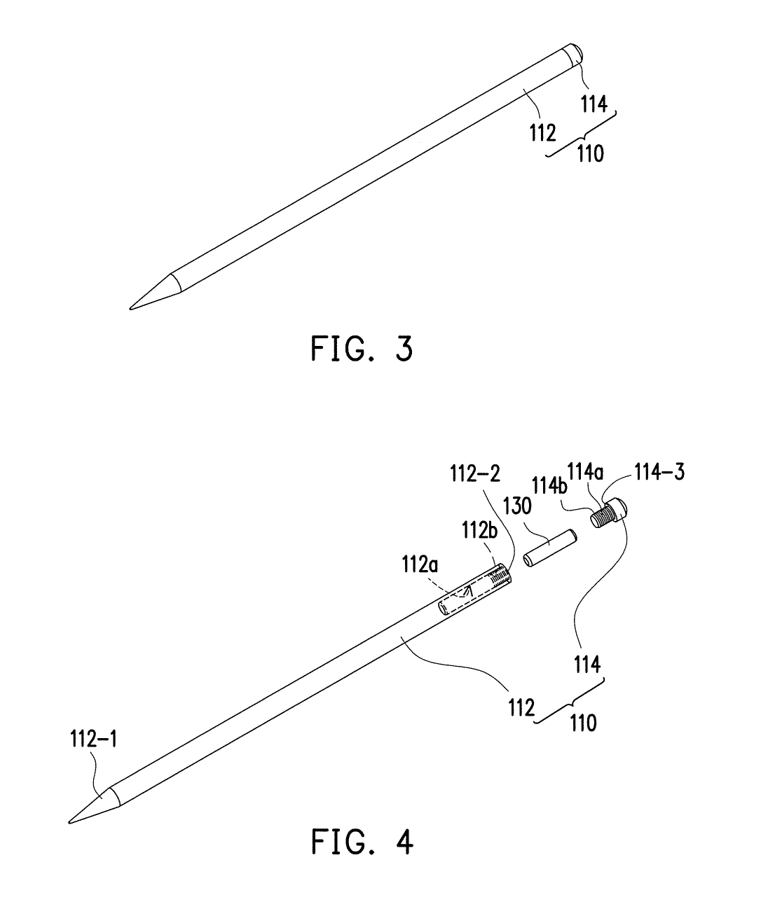

FIG. 3 is a three-dimensional view illustrating a rod of the stylus in FIG. 1. FIG. 4 is an exploded view illustrating a rod and a magnetic element in the stylus depicted in FIG. 1. With reference to FIG. 2, FIG. 3, and FIG. 4, in the present embodiment, the rod 110 includes a first part 112 and a second part 114. The first part 112 has a first end 112-1 and a second end 112-2, and the first end 112-1 is tapered to form a tip. The second part 114 has a third end 114-3 that is connected to the second end 112-2 of the first part 112. A chamber 110a is formed at the location where the first and second parts 112 and 114 are connected to each other, so as to accommodate the magnetic element 130. Particularly, a slot 112a is configured at the second end 112-2 of the first part 112, a protrusion 114a is configured at the third end 114-3 of the second part 114, and the protrusion 114a and the slot 112a are locked to each other and together constitute the chamber 110a. In the present embodiment, an inner thread of the slot 112a of the first part 112 is coupled to an outer thread 114b of the protrusion 114a of the second part 114, such that the slot 112a and the protrusions 114a are fastened to each other.

In the present embodiment, the magnetic element 130 described herein may be shaped as a column, and the shape of the slot 112a may correspond to the shape of the magnetic element 130 (i.e., the slot 112a may also be shaped as a column). Besides, there may be an adhesive on a surface of the magnetic element 130, and the magnetic element 130 is adhered to the chamber 110a by the adhesive, so as to ensure that the magnetic element 130 does not move in the chamber 110a. Alternatively, the shape of the chamber 110a may be designed to be completely consistent with that of the magnetic element 130, and thereby the magnetic element 130 does not move in the chamber 110a. For some applicative purposes, a length of the first part 112 is greater than a length of the second part 114.

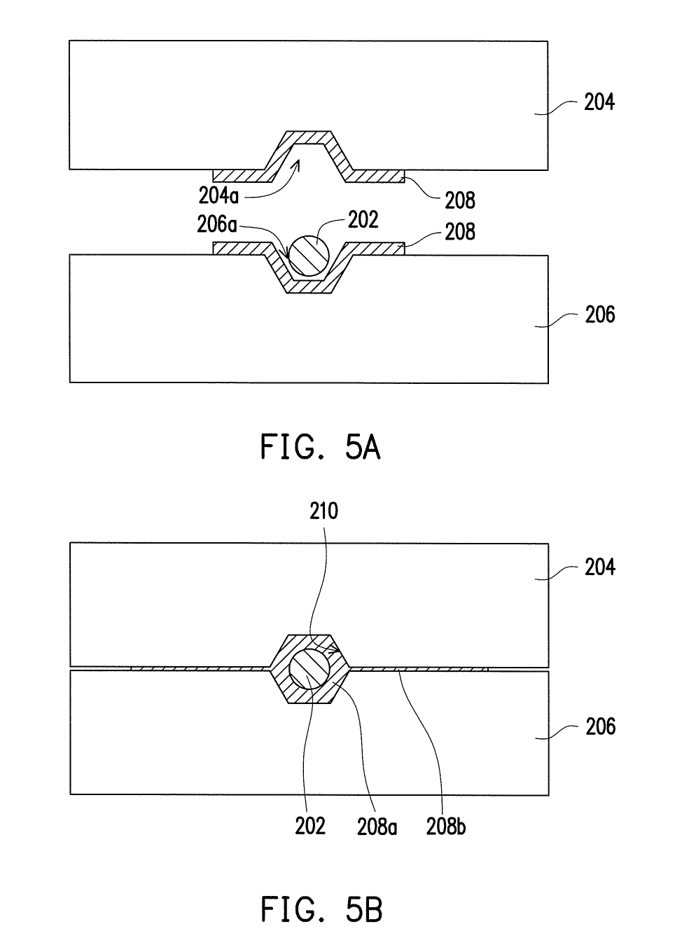

FIG. 5A and FIG. 5B illustrate a method for manufacturing a stylus in a cross-sectional manner according to an embodiment of the application. With reference to FIG. 5A, in the method for manufacturing a stylus, a rod 202 (similar to the rod 110 shown in FIG. 3) is provided, and the rod 202 is placed between a first mold core 204 and a second mold core 206. In the present embodiment, before the first mold core 204 and the second mold core 206 are combined, a semi-finished product 208 of the conductive material is placed in the first and second mold cores 204 and 206, such that the rod 202 is placed on the semi-finished product 208 of the conductive material on the first mold core 204.

With reference to FIG. 5B, the first and second mold cores 204 and 206 are then combined, such that the rod 202 is located in the mold cavity 210 constructed by the first and second mold cores 204 and 206. Here, a longitudinal direction of the rod 202 is substantially parallel to that of the mold cavity 210. In the present embodiment, the semi-finished product 208 of the conductive material encapsulates the rod 202, so as to form a conductive material 208a similar to the conductive material 120 shown in FIG. 2. The residual conductive material 208b may be removed to embellish the appearance of the conductive material 208a.

In another embodiment that is not shown in the drawings but is similar to the embodiment illustrated in FIG. 5A and FIG. 5B, if the rod 202 is correctly positioned in the mold cavity 210, it is likely not to configure the semi-finished product 208 of the conductive material on the first and second mold cores 204 and 206 before the first and second mold cores 204 and 206 are combined; instead, the conductive material 208a may be injected into the mold cavity 210 through liquid injection molding and may then be cured. Hence, in a method of forming the conductive material 208a to encapsulate the rod 202, the semi-finished product 208 of the conductive material is configured in the first and second mold cores 204 and 206 in advance, and the semi-finished product 208 of the conductive material is cured after the first and second mold cores 204 and 206 are combined. Alternatively, the conductive material 208a may be injected into the mold cavity 210 (constituted by the first and second mold cores 204 and 206) directly through liquid injection molding, and the conductive material 208a is then cured.

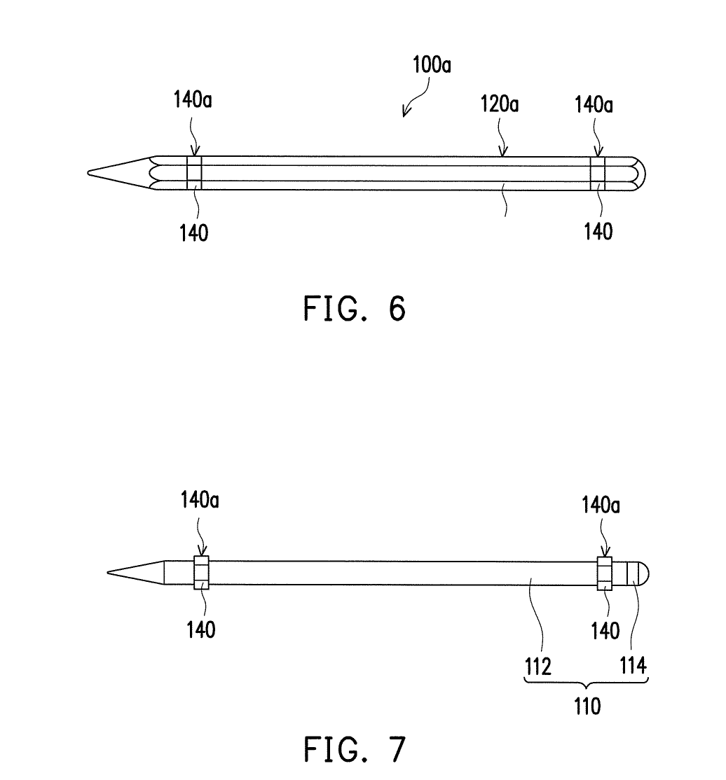

FIG. 6 illustrates a stylus according to another embodiment of the application. FIG. 7 is a side view illustrating a rod of the stylus in FIG. 6. With reference to FIG. 6 and FIG. 7, in comparison with the stylus depicted in FIG. 1 and FIG. 3, the stylus 100a described in the present embodiment further includes one or more protrusions 140 that protrude from an outer side of the rod 110 and are not encapsulated by the conductive material 120. In the present embodiment, the protrusions 140 and the rod 110 may be integrally formed, and therefore the protrusions 140 may be made of the same material as that of the rod 110. Besides, the outer surfaces 140a of the protrusions 140 not encapsulated by the conductive material are flush with an outer surface 120a of the conductive material 120. In addition to the embellishment function, the protrusions 140 may perform other functions which will be described below.

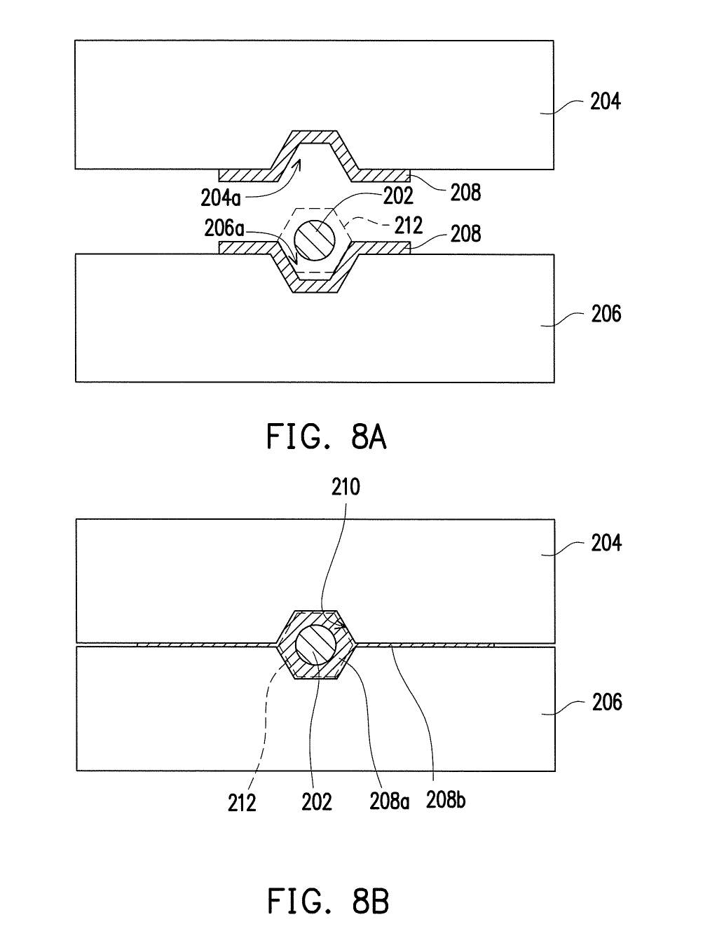

FIG. 8A and FIG. 8B illustrate a method for manufacturing a stylus in a cross-sectional manner according to another embodiment of the application. With reference to FIG. 8A, in the method for manufacturing a stylus, a rod 202 (similar to the rod 110 shown in FIG. 7) is provided, and the rod 202 is placed between a first mold core 204 and a second mold core 206. In the present embodiment, before the first mold core 204 and the second mold core 206 are combined, a semi-finished product 208 of the conductive material is placed in the first and second mold cores 204 and 206, such that the rod 202 is placed on the semi-finished product 208 of the conductive material on the first mold core 204.

With reference to FIG. 8B, the first and second mold cores 204 and 206 are then combined, such that the rod 202 is located in a mold cavity 210 constructed by the first and second mold cores 204 and 206. Here, a longitudinal direction of the rod 202 is substantially parallel to that of the mold cavity 210. In the present embodiment, the semi-finished product 208 of the conductive material encapsulates the rod 202, so as to form a conductive material 208a similar to the conductive material 120 shown in FIG. 2. Besides, the residual conductive material 208b may be removed to embellish the appearance of the conductive material 208a.

It should be mentioned that one or plural protrusions 212 (similar to the protrusions 140 shown in FIG. 6 and FIG. 7) protrude from the outer side of the rod 202, so as to ensure that the rod 202 is positioned in the mold cavity 210. In particular, the rod 202 may be fixed at a predetermined location in the mold cavity 210 by means of the protrusions 212, such that the thickness of the subsequently-formed conductive material 214 on the outer side of the rod 202 may comply with relevant requirements.

In another embodiment that is not shown in the drawings but is similar to the embodiment illustrated in FIG. 8A and FIG. 8B, if the rod 202 is correctly positioned in the mold cavity 210 by means of the protrusions 212, it is likely not to configure the semi-finished product 208 of the conductive material on the first and second mold cores 204 and 206 before the first and second mold cores 204 and 206 are combined; instead, the conductive material 208a may be injected into the mold cavity 210 through liquid injection and may then be cured. Hence, in a method of forming the conductive material 208a to encapsulate the rod 202, the semi-finished product 208 of the conductive material is configured in the first and second mold cores 204 and 206 in advance, and the semi-finished product 208 of the conductive material is cured after the first and second mold cores 204 and 206 are combined. Alternatively, the conductive material 208a may be injected into the mold cavity 210 (constituted by the first and second mold cores 204 and 206) directly through liquid injection molding, and the conductive material 208a is then cured.

To sum up, the stylus described herein is composed of the rod and the conductive material that encapsulates the rod. For some applicative purposes, the magnetic element may be placed in the rod of the stylus described herein. Moreover, according to the method for manufacturing the stylus described above, the rod is positioned in the mold cavity, such that the conductive material may encapsulate the rod to form the stylus. The protrusions protruding from the rod serve to position the rod in the molding cavity, such that the thickness of the subsequently-formed conductive material on the outer side of the rod may comply with relevant requirements.

Although the application has been described with reference to the above embodiments, it will be apparent to one of the ordinary skill in the art that modifications to the described embodiment may be made without departing from the spirit of the application. Accordingly, the scope of the application will be defined by the attached claims not by the above detailed descriptions.

What is claimed is:

1. A stylus comprising:
a rod having a first end, the first end being tapered to form a tip; and
a conductive material covering all surfaces of the rod.

2. The stylus as recited in claim 1, further comprising:
a protrusion located on the surface of the rod, the protrusion being not encapsulated by the conductive material.

3. The stylus as recited in claim 2, wherein the protrusion and the rod are integrally formed.

4. A stylus comprising:
a rod comprising:
a first part having a first end and a second end, the first end being tapered to form a tip; and
a second part having a third end connected to the second end; and
a conductive material encapsulating the first and second ends.

5. The stylus as recited in claim 4, wherein a chamber is formed at a location where the first and second parts are connected to each other.

6. The stylus as recited in claim 5, further comprising:
a magnetic element located in the chamber.

7. The stylus as recited in claim 5, wherein a slot is configured at the second end of the first part, a protrusion is configured at the third end of the second part, and the protrusion and the slot are fastened to each other and together constitute the chamber.

8. The stylus as recited in claim 7, wherein an adhesive on a surface of the magnetic element adheres the magnetic element to the slot.

9. The stylus as recited in claim 4, wherein a length of the first part is greater than a length of the second part.

10. The stylus as recited in claim 1, further comprising:
a protrusion protruding from a surface of the first part and being not encapsulated by the conductive material.

11. The stylus as recited in claim 10, wherein the protrusion and the first part are integrally formed.

12. The stylus as recited in claim 10, wherein a surface of the protrusion parallel to the first part is flush with an outer surface of the conductive material.

13. A method for manufacturing a stylus, the method comprising:
providing a rod;
placing the rod between a first mold core and a second mold core;
combining the first and second mold cores, such that the rod is located in a mold cavity constructed by the first and second mold cores;
forming a conductive material in the mold cavity;
curing the conductive material on a surface of the rod to form a stylus;
separating the first and second mold cores from each other; and
taking out the resultant stylus located between the first and second mold cores.

14. The method as recited in claim 13, wherein in the step of forming the conductive material, a semi-finished product of the conductive material is placed in the first and second mold cores before the first and second mold cores are combined, such that the rod is placed on the semi-finished product of the conductive material on the first mold core.

15. The method as recited in claim 13, wherein in the step of forming the conductive material, the conductive material is injected into the mold cavity after the first and second mold cores are combined, so as to encapsulate the rod.

16. The method as recited in claim 13, further comprising configuring a magnetic element in the rod.

17. The method as recited in claim 13, wherein in the step of combining the first and second mold cores, a protrusion protrudes from an outer side of the rod, so as to ensure that the rod is fixed into the mold cavity at a predetermined location.
